(19) United States
(12) Patent Application Publication
(10) Pub. No.: US 2024/0159969 A1
(43) Pub. Date: May 16, 2024

(54) OPTICAL CONNECTING STRUCTURE, PACKAGE STRUCTURE, OPTICAL MODULE AND MANUFACTURING METHOD FOR PACKAGE STRUCTURE

(71) Applicant: Nippon Telegraph and Telephone Corporation, Tokyo (JP)

(72) Inventors: Yoshiyuki Doi, Tokyo (JP); Yuzo Ishii, Tokyo (JP); Satoshi Tsunashima, Tokyo (JP); Kota Shikama, Tokyo (JP)

(21) Appl. No.: 18/549,471

(22) PCT Filed: Mar. 12, 2021
(86) PCT No.: PCT/JP2021/010038

§ 371 Date: Sep. 7, 2023

(51) Int. Cl. G02B 6/32; G02B 6/42

(52) U.S. Cl. CPC G02B 6/322; G02B 6/4206; G02B 6/428

(57) ABSTRACT

An embodiment optical connecting structure is an optical connecting structure in a package structure connected to an optical fiber and including a first electric wiring board and a second electric wiring board facing the first electric wiring board. The optical connecting structure includes an optical element arranged on either the first electric wiring board or the second electric wiring board and a GRIN lens arranged on a surface of the second electric wiring board facing the first electric wiring board, in which one end surface of the GRIN lens faces an end surface of the optical element.

### CROSS-REFERENCE TO RELATED APPLICATIONS

This application is a national phase entry of PCT Application No. PCT/JP2021/010038, filed on Mar. 12, 2021, which application is hereby incorporated herein by reference.

### TECHNICAL FIELD

The present invention relates to an optical connecting structure used for connecting an optical element and an optical fiber, a package structure, an optical module, and a method of manufacturing the package structure.

### BACKGROUND

With a recent rapid increase in Internet traffic, it has been required to increase communication capacity of a data center network. Further, in order to meet an increase in transmission capacity and a reduction in power consumption, optical interconnection for optical transmission has been introduced even in short or medium range applications.

In a typical method of the optical interconnection, signal processing is achieved by transmission between a light emitting element such as a laser diode (LD) arranged on a printed circuit board and a light receiving element such as a photodiode (PD) arranged thereon by using an optical transmission medium such as an optical waveguide or an optical fiber.

Depending on a transmission method, an optical modulator and the like are integrated in the light emitting element or are discretely connected thereto, and the light emitting element is further connected to, for example, a driver that performs electro-optic conversion. A configuration including the light emitting element, the optical modulator, the driver, and the like is mounted as an optical transmitter on an electric mounting board such as a printed circuit board (PCB).

Similarly, an optical processor and the like are integrated in the light receiving element or are discretely connected thereto, and the light receiving element is further connected to, for example, an electric amplifier circuit that performs optic-electro conversion. A configuration including the light receiving element, the optical processor, the electric amplifier circuit, and the like is mounted as an optical receiver on a printed circuit board.

An optical transmitter/receiver or the like, which is obtained by integrating the optical transmitter with the optical receiver, is mounted in a package or on a printed circuit board and is optically connected to an optical transmission medium such as an optical fiber, thereby achieving optical interconnection. Depending on topology, the optical interconnection is achieved via a relay such as an optical switch.

In conventional optical interconnection (a mounting structure of optical components), each component is (discretely) mounted in an individual package. However, it is difficult to collectively manufacture and mass-produce the above mounting structures.

As a technique for mounting electrical and electronic components, fan-out wafer-level packaging (FOWLP) for packaging components on a wafer has high mass productivity and has been implemented in recent years. In fan-out panel-level packaging (FOPLP) for packaging components on a panel (panel level), the components can be mounted in a larger area than that of FOWLP, thereby having higher mass productivity.

Meanwhile, the light emitting element, the light receiving element, and the optical modulator used for the optical interconnection are practically applied as elements made from materials such as semiconductors including silicon and germanium or III-V semiconductors represented by indium phosphide (InP), gallium arsenide (GaAs), indium gallium arsenide (InGaAs), and the like. There has recently been developed an optical waveguiding optical transmitter/receiver in which a silicon optical circuit (silicon photonics), an indium phosphide optical circuit, or the like having a light propagation mechanism is integrated together with the above elements. The optical modulator may be made from not only semiconductors but also ferroelectric materials such as lithium niobate or polymers.

An optical functional element including, for example, a planar lightwave circuit made from quartz glass or the like may be further integrated together with the above light emitting element, light receiving element, and optical modulator. Examples of the optical functional element include a splitter, a wavelength multiplexer/demultiplexer, an optical switch, a polarization control element, and an optical filter. Hereinafter, a device in which the light emitting element, the light receiving element, the optical modulator, the optical functional element, an optical amplifier, and the like having the optical propagation and waveguide mechanisms are integrated will be referred to as an optical waveguide device.

In the optical waveguide device, a silicon photonics chip has high integration, high mass productivity, and high affinity with electrical components and draws attention as a key device for achieving next-generation optical interconnection (Non Patent Literature 1).

A method of connecting an optical transmitter/receiver in which a silicon photonics chip, a driver, an electric amplifier circuit, and the like are integrated to electric wiring on a board is wire bonding, flip chip connection, or connection using a ball-grid array (BGA), land-grid array (LGA), pin-grid array (PGA), copper pillar, or the like. In those connections, the optical transmitter/receiver may be connected to an electric mounting board via another package substrate such as an interposer component as necessary.

One method of connecting a silicon photonics chip to an optical fiber is a structure that connects the silicon photonics chip to an optical fiber array integrated with glass or the like having a V-shaped groove. In the structure, in order to connect a core of each optical fiber and a core of each waveguide of the optical waveguide device with low loss, the optical waveguide device and the optical fiber are positioned (hereinafter, referred to as aligned) in submicrons and are then adhesively fixed.

### CITATION LIST

### Non Patent Literature

Non Patent Literature 1: K. Shikama et al., “Multicore-Fiber Receptacle With Compact Fan-In/Fan-Out Device for SDM Transceiver Applications,” in Journal of Lightwave Technology, vol. 36, no. 24, pp. 5815-5822, 15 Dec. 15, 2018, doi: 10.1109/JLT.2018.2879100.

### SUMMARY

### Technical Problem

However, the structure in which the optical fiber is adhesively connected to the silicon photonics chip has low durability against heat treatment or other processes in FOWLP or FOPLP. Therefore, it is difficult to use FOWLP or FOPLP for mounting optical components.

Further, the conventional structure in which the optical fiber is adhesively connected to the silicon photonics chip by using an adhesive or the like has the following problems.

In order to cause the optical fiber array to directly adhere to the silicon photonics chip, it is necessary to optically polish an end surface of the silicon photonics chip.

Further, a side surface of the chip is an adhesive surface, and thus an adhesion area is limited. This makes it difficult to obtain sufficient adhesive force.

Furthermore, the optical fiber is fixedly connected as a pigtail, and thus, in the next board mounting or other processes, it is necessary to perform, for example, a process for maintaining (stabilizing) the fixed connection state of the optical fiber. This reduces mass productivity (improvement in throughput and stabilization) of an assembly process.

As described above, the structure that adhesively connects the optical fiber to the silicon photonics chip in the package structure and the optical module has problems.

Further, in order to use FOWLP or FOPLP for mounting optical components, it is necessary to connect the silicon photonics chip and the optical fiber, without adhesively connecting the silicon photonics chip and the optical fiber.

### Solution to Problem

In order to solve the above problems, an optical connecting structure according to embodiments of the present invention is an optical connecting structure in a package structure connected to an optical fiber and including a first electric wiring board and a second electric wiring board facing the first electric wiring board, the optical connecting structure including: an optical element arranged on either the first electric wiring board or the second electric wiring board; and a GRIN lens arranged on a surface of the second electric wiring board facing the first electric wiring board, in which one end surface of the GRIN lens faces an end surface of the optical element.

A method of manufacturing a package structure according to embodiments of the present invention includes: a step of mounting an optical element including a waveguide for alignment on a surface near an opening of a first electric wiring board; a step of mounting a GRIN lens on a surface of a second electric wiring board; a step of causing the GRIN lens to pass through the opening of the first electric wiring board, causing the surface of the first electric wiring board and the surface of the second electric wiring board to face each other, and bonding the first electric wiring board and the second electric wiring board; a step of forming a molding resin between the first electric wiring board and the second electric wiring board; a step of arranging an adapter so as to input and output light between the adapter and the GRIN lens; a step of detachably connecting a ferrule to which a multicore optical fiber is fixed to the adapter; a step of inputting light to one optical fiber of the multicore optical fiber; a step of measuring an intensity of the light propagated through the waveguide and output from another optical fiber of the multicore optical fiber; and a step of moving positions of the reflection structure and the adapter to fix the reflection structure and the adapter at the positions where the intensity of the light is maximum.

### Advantageous Effects of Embodiments of the Invention

According to embodiments of the present invention, it is possible to provide an optical connecting structure, a package structure, an optical module, and a method of manufacturing the package structure capable of improving mass productivity, without causing an optical fiber to directly adhere to a silicon photonics chip.

### BRIEF DESCRIPTION OF THE DRAWINGS

FIG. 1 is a schematic side view illustrating a configuration of an optical module according to a first embodiment of the present invention.

FIG. 2 is a schematic top view for describing an operation of an optical connecting structure according to the first embodiment of the present invention.

FIG. 3 is a schematic side view illustrating a configuration of an optical module according to a second embodiment of the present invention.

FIG. 4 illustrates schematic top views for describing an operation of an optical connecting structure according to the second embodiment of the present invention.

FIG. 5A illustrates a method of manufacturing a package structure according to the second embodiment of the present invention.

FIG. 5B illustrates a method of manufacturing a package structure according to the second embodiment of the present invention.

FIG. 5C illustrates a method of manufacturing a package structure according to the second embodiment of the present invention.

FIG. 5D illustrates a method of manufacturing a package structure according to the second embodiment of the present invention.

FIG. 5E illustrates a method of manufacturing a package structure according to the second embodiment of the present invention.

FIG. 5F illustrates a method of manufacturing a package structure according to the second embodiment of the present invention.

FIG. 5G illustrates a method of manufacturing a package structure according to the second embodiment of the present invention.

FIG. 5H illustrates a method of manufacturing a package structure according to the second embodiment of the present invention.

FIG. 5I illustrates a method of manufacturing a package structure according to the second embodiment of the present invention.

FIG. 5J illustrates a method of manufacturing a package structure according to the second embodiment of the present invention.

FIG. 6A illustrates an effect of a package structure according to an embodiment of the present invention.

FIG. 6B illustrates an effect of a package structure according to an embodiment of the present invention.

FIG. 7 is a schematic side view illustrating an example of a configuration of an optical module according to an embodiment of the present invention.

FIG. 8 is a schematic side view illustrating an example of a configuration of an optical module according to an embodiment of the present invention.

FIG. 9 is a schematic side view illustrating an example of a configuration of an optical module according to an embodiment of the present invention.

FIG. 10 is a schematic side view illustrating an example of a configuration of an optical module according to an embodiment of the present invention.

### DETAILED DESCRIPTION OF ILLUSTRATIVE EMBODIMENTS

### First Embodiment

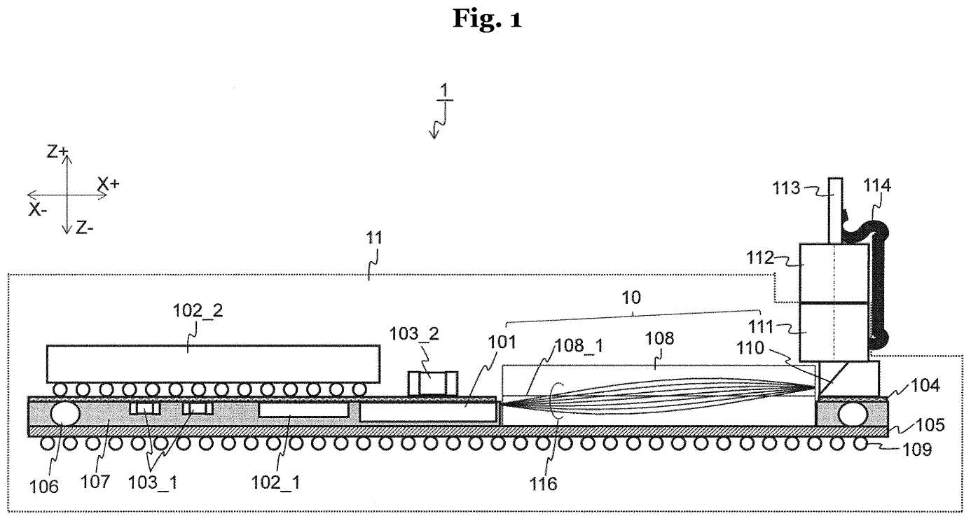

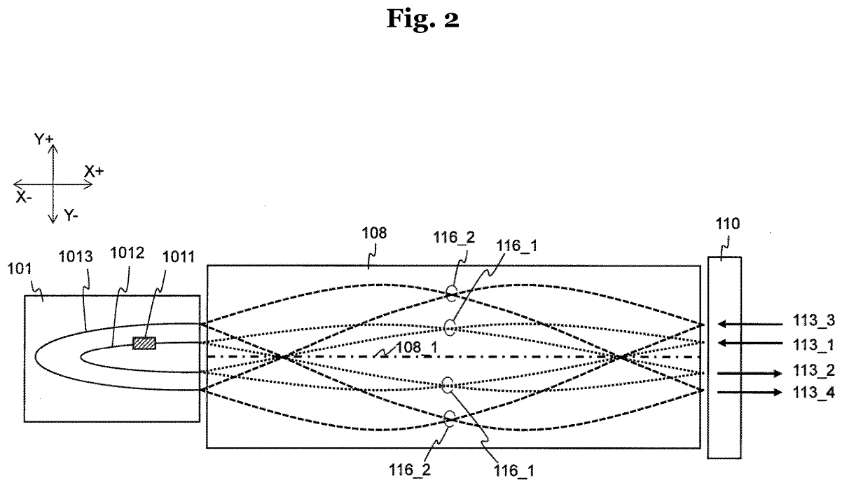

An optical connecting structure, a package structure, and an optical module according to a first embodiment of the present invention will be described with reference to FIGS. 1 and 2.

### Configurations of Package Structure and Optical Module

FIG. 1 is a schematic side view illustrating a configuration of an optical module 1 according to the present embodiment. Hereinafter, when the optical module 1 is configured as illustrated in FIG. 1, a surface on the Z+ side in FIG. 1 will be referred to as “upper surface”, and a surface on the Z− side in FIG. 1 will be referred to as “lower surface”.

The optical module 1 according to the present embodiment includes a package structure 11, a ferrule 112, and an optical fiber 113. The optical fiber 113 is fixed to the ferrule 112. The package structure 11 and the ferrule 112 are fixed by using a clip 114.

The optical fiber 113 is a multicore optical fiber and includes a plurality of optical fibers. In the following embodiments of the present invention, the optical fiber 113 includes a plurality of optical fibers 113_1, 113_2, 113_3, and 113_4 as an example.

In the package structure 11, a first electric wiring board 104 and a second electric wiring board 105 are arranged to face each other.

A silicon photonics chip 101, an IC 102_1, and a passive component 103_1 are arranged on a lower surface of the first electric wiring board 104, in other words, on a surface facing the second electric wiring board 105.

An IC 102_2, a passive component 103_2, and a prism 110 are arranged on an upper surface of the first electric wiring board 104, in other words, on a surface opposite to the surface facing the second electric wiring board 105.

The silicon photonics chip 101 may be arranged not only on the lower surface of the first electric wiring board 104 but also on an upper surface of the second electric wiring board 105 and only needs to be arranged between the first electric wiring board 104 and the second electric wiring board 105.

A gradient index (GRIN) lens 108 is arranged on the upper surface of the second electric wiring board 105, in other words, on a surface facing the first electric wiring board 104.

One end surface of the GRIN lens 108 is close to the silicon photonics chip 101. The other end surface of the GRIN lens 108 is close to the prism 110 mounted on the upper surface of the first electric wiring board 104.

The first electric wiring board 104 is, for example, a thin multilayer printed wiring board and has a thickness of 100 μm. The GRIN lens 108 is arranged to pass through an opening provided in a part of the first electric wiring board 104.

The first electric wiring board 104 and the second electric wiring board 105 are electrically connected via a connection terminal 106 and have a gap filled with a molding resin 107. The connection terminal 106 is, for example, a copper pillar, a copper pin, or a solder ball.

Electric connection portions 109 are formed on a lower surface of the second electric wiring board 105 and serve as an electric interface with an electric mounting board (not illustrated) such as a PCB on which an optical package is mounted. The electric connection portions 109 are BGA balls or an LGA pad.

The prism 110 is adhesively fixed to the upper surface of the first electric wiring board 104. An adapter 111 is arranged on an upper surface of the prism 110, in other words, on a surface opposite to a surface in contact with the first electric wiring board 104, and is adhesively fixed thereto.

The prism 110 may be a mirror and only needs to have a structure (hereinafter, also referred to as “reflection structure”) having a reflection function of converting a substantially horizontal optical path input to and output from the silicon photonics chip 101 and a substantially vertical optical path input to and output from the adapter 111.

The ferrule 112 is not adhesively fixed to the adapter 111 and is a detachable connector interface.

The ferrule 112 and the adapter 111 may be rectangular or cylindrical. In a case where the ferrule 112 and the adapter 111 are rectangular components, both the ferrule and the adapter are connected with high accuracy by providing two round holes for guide pins in both the ferrule and the adapter and inserting guide pins (not illustrated) into the round holes, as in a method of fitting an MT ferrule.

The clip 114 is used to hold the contact between both the ferrule and the adapter. In a case where the ferrule and the adapter are cylindrical components, the ferrule and the adapter are connected by using a cylindrical sleeve or a split sleeve, as in a method of fitting an LC ferrule.

The GRIN lens 108 is a cylindrical optical component and is a gradient index lens in which the refractive index is parabolically changed from a center axis 108_1 of the cylinder toward an outer peripheral portion. A focal length of the GRIN lens is changed by changing a length thereof, and a lens characteristic thereof is expressed by Expression (1).

Expression (1): Z=2πP/√A (1)

Z denotes the length of the GRIN lens, VA denotes a refractive index distribution constant determined based on a material or manufacturing method, and P denotes a pitch representing a meandering period of a light beam passing through the lens.

The GRIN lens 108 in FIG. 1 has a pitch of about 0.5 (P≈0.5), and a general GRIN lens having a diameter of 1.8 mm has the length Z of about 9.6 mm.

In the silicon photonics chip 101, for example, a modulator, a mixer circuit, a photodiode, and the like are formed together with a waveguide.

The passive components 103_1 and 103_2 are, for example, capacitors or optical splitters.

### Operation of Optical Connecting Structure

In the package structure 11 according to the present embodiment, light output from the silicon photonics chip 101 sequentially propagates through the GRIN lens 108, the prism 110, and the adapter 11 and is input to the optical fiber 113 fixed to the ferrule 112. Meanwhile, light input from the optical fiber 113 sequentially propagates through the adapter 111, the prism 110, and the GRIN lens 108 and is input to the silicon photonics chip 101.

The optical connecting structure 10 includes the silicon photonics chip 101, the GRIN lens 108, the prism 110, and the adapter 111. Hereinafter, propagation of light in the optical connecting structure 10 will be described with reference to FIGS. 1 and 2.

FIG. 2 is a schematic top view of the optical connecting structure 10 for describing propagation paths of light (the adapter 111 is not illustrated). Solid lines 116 in FIG. 1 and dotted lines 116_1 and broken lines 116_2 in FIG. 2 indicate paths of light propagating through the GRIN lens 108.

When the propagation of the light in the optical connecting structure 10 is viewed from the top, as illustrated in FIG. 2, light beams input from different optical fibers 113_1 and 113_3 are propagated (condensed) by the GRIN lens 108 through different paths 116_1 and 116_2 and are input (coupled) to different waveguides 1012 and 1013 of the silicon photonics chip 101.

The light beams propagated through the waveguides 1012 and 1013 are output from the silicon photonics chip 101, are propagated (condensed) by the GRIN lens 108 through the different paths 116_1 and 1162, and are input (coupled) to different optical fibers 113_2 and 113_4 via the prism 110 and the adapter 111.

The silicon photonics chip 101 herein includes, as an example, an optical element 1011, the first waveguide 1012, and the second waveguide 1013. In the present embodiment, the optical element 1101 is a modulator, but may be, for example, a mixer or a photodiode. The optical element 1101 is connected to the first waveguide 1102 and modulates input light to generate an optical signal, and the optical signal propagates through the first waveguide 1102. The second waveguide 1103 is used to adjust and align positions of components in a manufacturing process of the package structure 11 (described later).

As described above, the optical connecting structure 10 according to the present embodiment uses the GRIN lens 108. This makes it possible to easily input light input from different optical fibers to different waveguides of the silicon photonics chip 101 and to easily input light output from different waveguides to different optical fibers.

Next, vertical propagation of light in the optical connecting structure 10 will be described by exemplifying propagation of light output from the silicon photonics chip 101.

In the optical connecting structure 10, the silicon photonics chip 101 has a standard wafer thickness of 625 μm, and the first electric wiring board 104 and the second electric wiring board 105 have a gap of 800 μm.

The silicon photonics chip 101 is mounted below the first electric wiring board 104 in a “face-down” manner via the copper pillar (not illustrated) having a height of 40 μm provided on a surface (circuit surface) of the first electric wiring board. As a result, a light input/output portion of the silicon photonics chip 101 is arranged at a position about 40 μm lower than the lower surface of the first electric wiring board 104, in other words, at a position about 760 μm higher than the upper surface of the second electric wiring board 105.

As illustrated in FIG. 1, light output from the silicon photonics chip 101 is incident on one end surface (left side in FIG. 1) of the GRIN lens 108. In a case where the GRIN lens 108 has the diameter of 1.8 mm, a light incident position is offset downward by about 140 μm from the center axis 108_1 of the GRIN lens 108.

The light incident on the GRIN lens 108 is bent and propagated through the GRIN lens 108 according to a refractive index distribution, travels at 0.5 pitch (Z≈9.6 mm), and forms an image at a position offset upward by about 140 μm from the center axis 108_1 on the other end surface (right side in FIG. 1) of the GRIN lens 108. That is, the light forms an image at a position about 140 μm above the upper surface of the first electric wiring board 104.

The light output from the GRIN lens 108 is subjected to optical path conversion of about 90° by the prism 110 and is guided to the optical fiber 113 via the adapter 111 and the ferrule 112.

Meanwhile, light input from the optical fiber 113 is incident over the first electric wiring board 104 on the other end surface (right side in FIG. 1) of the GRIN lens 108 via the ferrule 112, the adapter 111, and the prism 110, is emitted below the first electric wiring board 104 from the one end surface (left side in FIG. 1) of the GRIN lens 108, and is propagated to the silicon photonics chip 101 through a path reverse to the above.

The light propagating through the silicon photonics chip 101 may be output from a light emitting element such as a semiconductor laser mounted in the package structure 11.

In the present embodiment, FIGS. 1 and 2 illustrate a case where the image is formed on an emission end surface of the GRIN lens 108 in order to simplify description. However, the image is not necessarily formed on the emission end surface of the GRIN lens 108 because it is necessary to consider an optical path length propagating through the prism 110 and the adapter 11. The image may be formed on an inclined surface (reflective surface) of the prism 110, or, even if the image is not completely formed (is not in focus), light only needs to be propagated within a range in which the package structure can operate.

As described above, in the package structure according to the present embodiment, a condensing state such as a focal diameter of output light is determined based on the length of the GRIN lens. Therefore, an optical system can be easily designed. Further, in a case where light is input with an offset from the center axis, an image is formed at a position symmetrical with respect to the center axis and is then output.

In the present embodiment, the center axis of the GRIN lens is arranged in substantially the same plane as the first electric wiring board. Therefore, it is possible to easily and optically accurately output light input to the GRIN lens from the silicon photonics chip arranged below the first electric wiring board so as to form an image at a position above the first electric wiring board symmetrical with respect to the center axis of the GRIN lens.

It is also possible to easily and optically accurately output light input to the GRIN lens from the prism arranged above the first electric wiring board so as to form an image at a position below the first electric wiring board symmetrical with respect to the center axis of the GRIN lens.

Here, “substantially the same plane as the first electric wiring board” includes the upper surface or lower surface (bottom surface) of the first electric wiring board and also includes a horizontal plane positioned between the upper surface and the lower surface. Therefore, the center axis of the GRIN lens is desirably parallel to the upper surface or the lower surface (bottom surface) of the first electric wiring board. The center axis of the GRIN lens is substantially parallel to the x direction in FIGS. 1 and 2.

### Second Embodiment

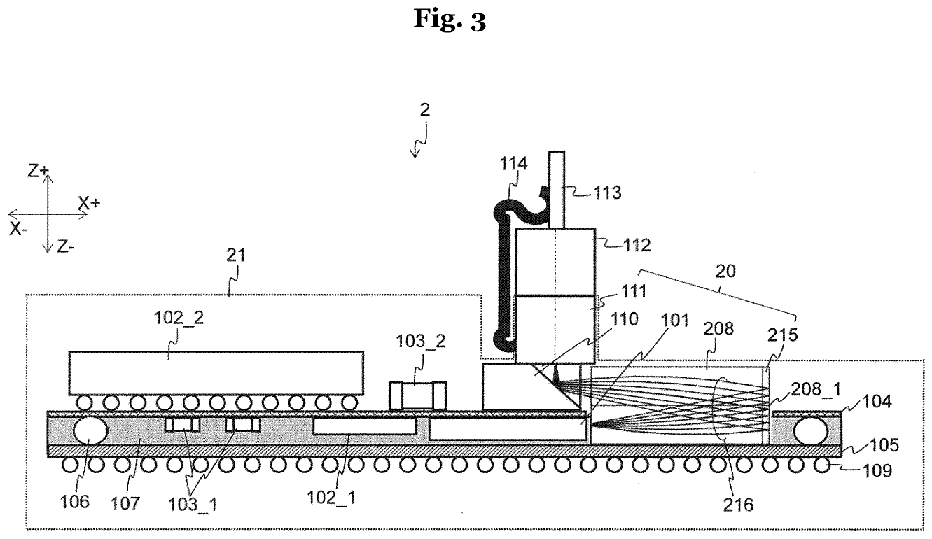

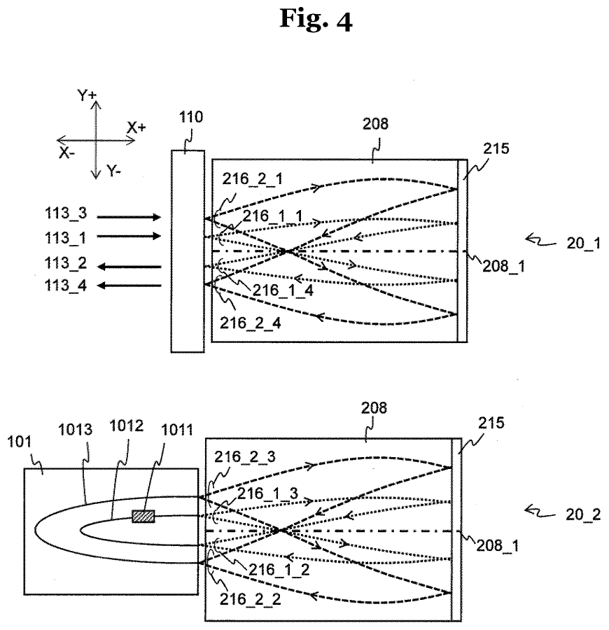

An optical connecting structure, a package structure, and an optical module according to a second embodiment of the present invention will be described with reference to FIGS. 3 and 4.

### Configurations of Optical Connecting Structure, Package Structure, and Optical Module

An optical module 2 according to the present embodiment has a substantially similar configuration to the optical module 1 according to the first embodiment, but a configuration of an optical connecting structure 20 in a package structure 21 is different.

The optical connecting structure 20 according to the present embodiment includes the silicon photonics chip 101, a GRIN lens 208, the prism 110, and the adapter 11.

The GRIN lens 208 has 0.25 pitch (about 4.8 mm). The pitch of the GRIN lens 208 is preferably 0.2 or more and 0.3 or less.

A reflective film 215 is further provided on an end surface (the other end surface) of the GRIN lens 208 opposite to an end surface (one end surface) close to the silicon photonics chip 101. The reflective film 215 is formed on the other end surface of the GRIN lens 208 by, for example, coating a reflective material (e.g., gold) or bonding a mirror component.

The prism 110 and the adapter 11 are arranged at the center of the package structure 21, as compared with the first embodiment.

### Operation of Optical Connecting Structure

In the optical connecting structure 20 according to the present embodiment, input/output light in the silicon photonics chip 101 propagates through the GRIN lens 208, the prism 110, and the adapter 111 in a substantially similar way to the first embodiment, but a path of the light in the GRIN lens 208 is different.

Hereinafter, propagation of light in the optical connecting structure 20 will be described with reference to FIGS. 3 and 4.

FIG. 4 illustrates schematic top views of the optical connecting structure 20 for describing propagation paths of light (the adapter 111 is not illustrated). A schematic top view 20_1 illustrates the optical connecting structure 20 above the first electric wiring board 104, and a schematic top view 202 illustrates the optical connecting structure 20 below the first electric wiring board 104.

Solid lines 216 in FIG. 3 and broken lines 216_1_1 to 216_1_4 and broken lines 216_2_1 to 216_2_4 in FIG. 4 indicate paths of light propagating through the GRIN lens 208.

As an example, the silicon photonics chip 101 has a similar configuration to that of the first embodiment. The first waveguide 1102 is a waveguide for optical signals. The second waveguide 1103 is used to adjust and align positions of components in a manufacturing process of the package structure 11 (described later).

When the propagation of the light in the optical connecting structure 20 is viewed from above, light beams input from different optical fibers 113_1 and 113_3 are propagated (condensed) by the GRIN lens 208 through different paths 216_1_1 and 216_2_1 and are reflected by the reflective film 215 (20_1 in FIG. 4).

The reflected light beams are propagated (condensed) through the paths 216_1_2 and 216_2_2 in a region below the first electric wiring board 104 of the GRIN lens 208 and are input (coupled) to the different waveguides 1012 and 1013 of the silicon photonics chip 101, respectively (20_2 in FIG. 4).

The light beams propagated through the waveguides 1012 and 1013 are output from the silicon photonics chip 101, are propagated (condensed) through the different paths 116_1_3 and 116_2_3 in the region below the first electric wiring board 104 of the GRIN lens 208, and are reflected by the reflective film 215 (20_2 in FIG. 4).

The reflected light beams are propagated (condensed) through the paths 216_1_4 and 216_2_4 in a region above the first electric wiring board 104 of the GRIN lens 208 and are input (coupled) to the different optical fibers 113_2 and 113_4 via the prism 110 and the adapter 111 (20_1 in FIG. 4).

As described above, the optical connecting structure 20 according to the present embodiment uses the GRIN lens 208. This makes it possible to easily input light input from different optical fibers to different waveguides of the silicon photonics chip 101 and to easily input light output from different waveguides to different optical fibers.

Next, vertical propagation of light in the optical connecting structure 20 will be described by exemplifying propagation of light output from the silicon photonics chip 101.

As illustrated in FIG. 3, light output from the silicon photonics chip 101 is incident on one end surface (left side in FIG. 3) of the GRIN lens 208.

The light propagated through the GRIN lens 208 is reflected by the reflective film 215 on the other end surface (right side in FIG. 3) of the GRIN lens 208 and is emitted from the one end surface. An emission position at this time is offset upward by about 140 μm from a center axis 208_1, as in the first embodiment. That is, the position is offset upward by about 140 μm from the upper surface of the first electric wiring board 104.

The light output from the GRIN lens 208 is subjected to optical path conversion of about 90° by the prism 110 and is guided to the optical fiber 113 via the adapter 11 and the ferrule 112.

Meanwhile, light input from the optical fiber 113 is incident over the first electric wiring board 104 on the one end surface (left side in FIG. 3) of the GRIN lens 208 via the ferrule 112, the adapter 11, and the prism 110, is reflected by the reflective film 215 on the other end surface (right side in FIG. 3) of the GRIN lens 208, is emitted below the first electric wiring board 104 on the one end surface (left side in FIG. 3), and is propagated to the silicon photonics chip 101 through a path reverse to the above.

As described above, in the package structure according to the present embodiment, the center axis of the GRIN lens is arranged in substantially the same plane as the first electric wiring board, as in the first embodiment. Therefore, light input over the first electric wiring board can form an image below the first electric wiring board, whereas light input below the first electric wiring board can form an image above the first electric wiring board, and thus the light can be output easily and optically accurately.

Further, the length of the GRIN lens 208 can be reduced by about half in the optical connecting structure according to the present embodiment. This makes it possible to reduce the size of the entire package structure.

### Method of Manufacturing Package Structure

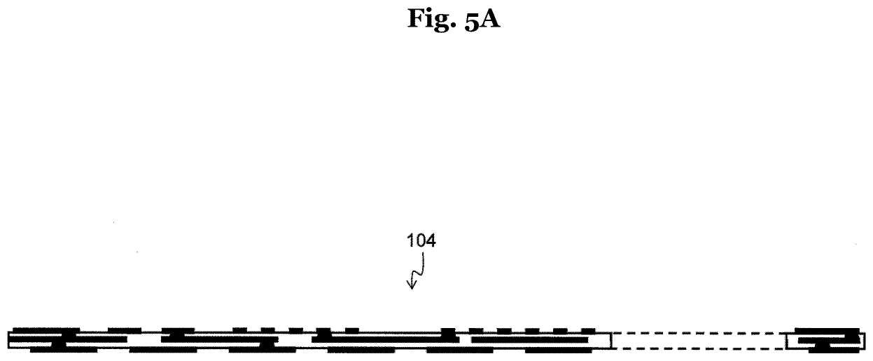

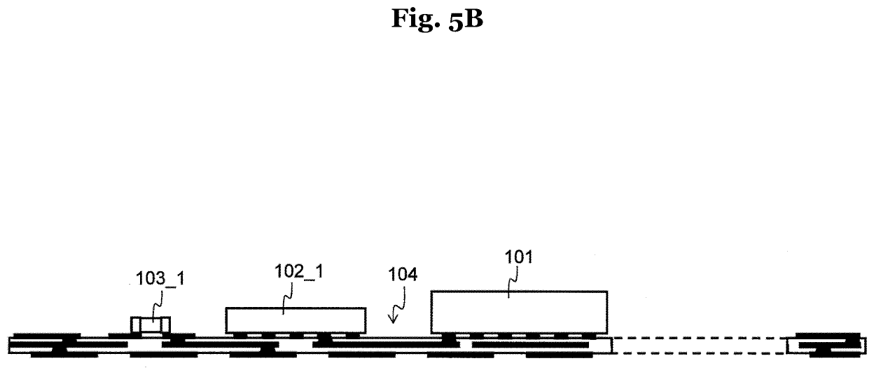

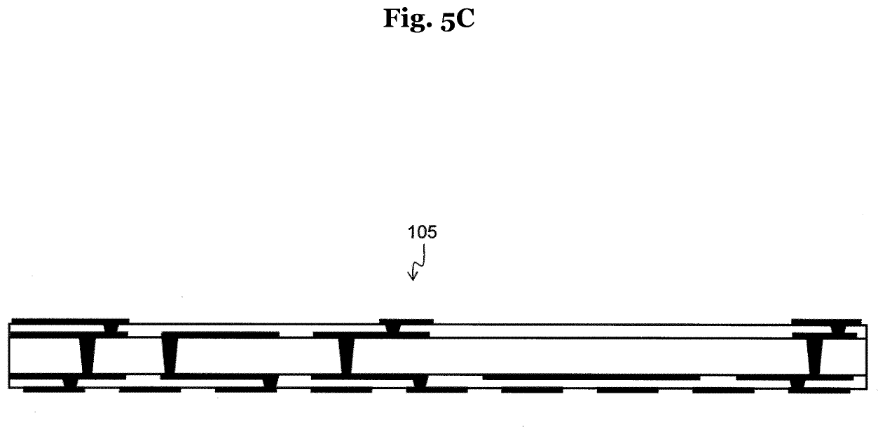

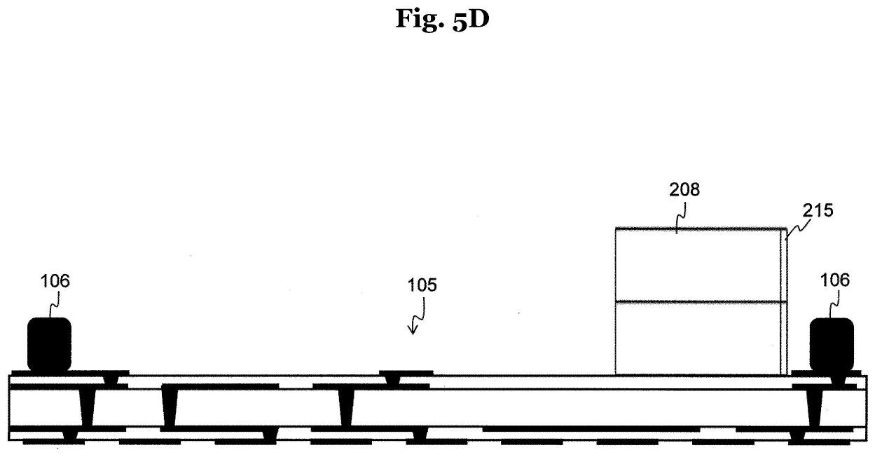

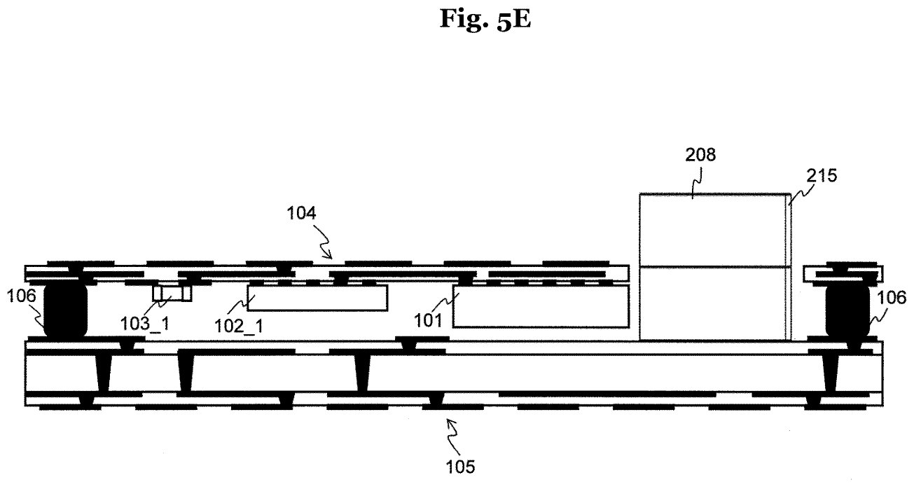

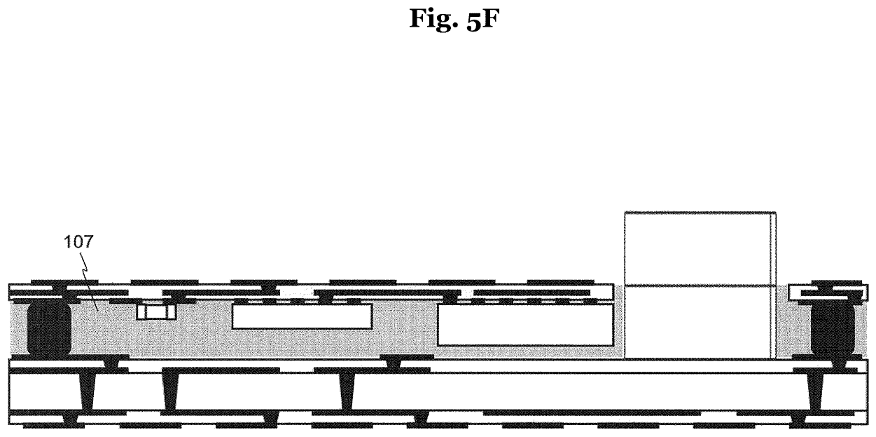

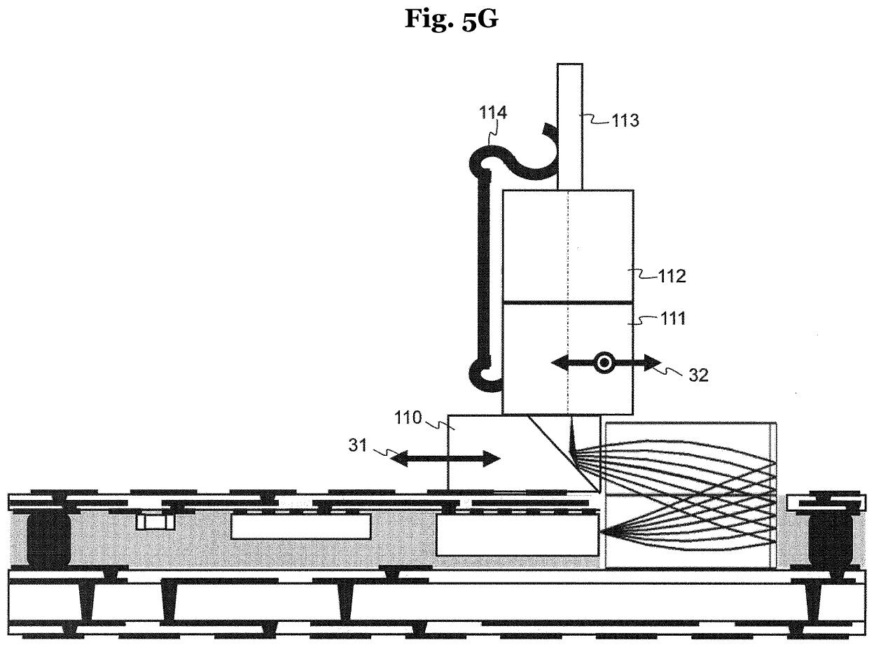

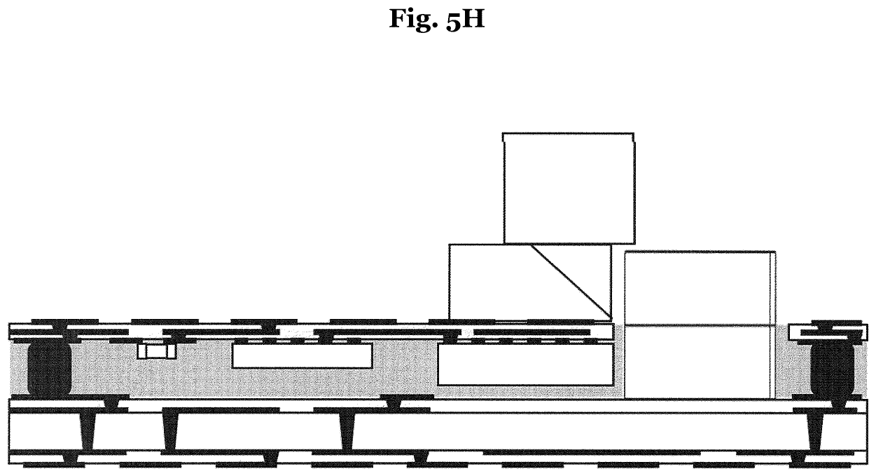

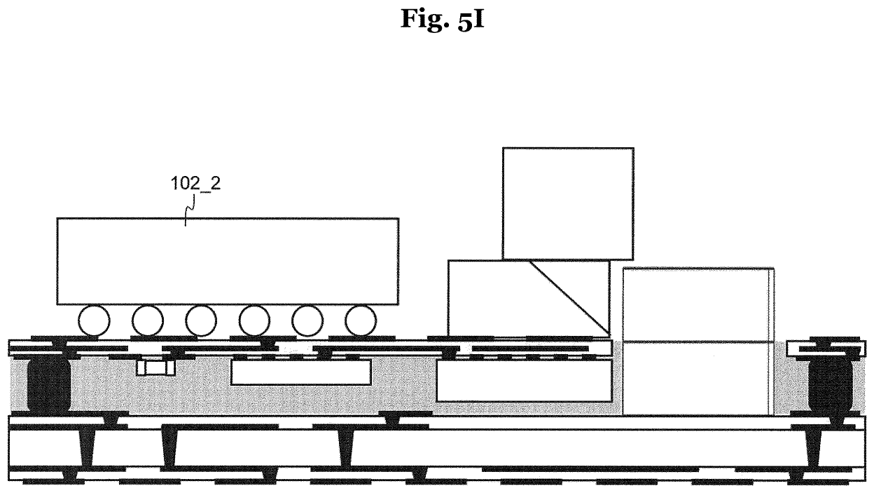

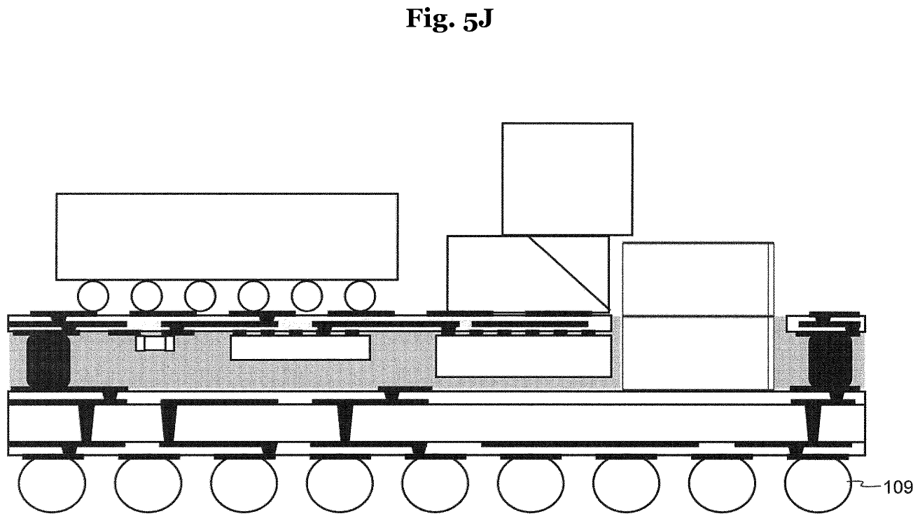

An example of a method of manufacturing the package structure 21 according to the present embodiment will be described with reference to FIGS. 5A to 5J.

First, the first electric wiring board 104 is fabricated (FIG. 5A). The first electric wiring board 104 is fabricated by stacking and heating a prepreg and a metal layer on both surfaces of a core layer (a layer including cured resin and a metal layer) to form a buildup layer, as in a normal semiconductor package substrate.

Alternatively, the first electric wiring board 104 may be a coreless substrate including only the buildup layer without using a core layer. Using the coreless substrate is desirable in the present embodiment because a thickness of the first electric wiring board 104 can be reduced.

Further, a rectangular opening for allowing the GRIN lens 208 to pass therethrough is provided in a part of the first electric wiring board 104 by laser or drilling (dotted lines in FIG. 5A).

Next, the silicon photonics chip 101 and the IC 102_1 are mounted on a surface of the first electric wiring board 104 via copper pillars, solder bumps, or the like (FIG. 5B). The silicon photonics chip 101 is arranged near the rectangular opening for allowing the GRIN lens 208 to pass therethrough.

Meanwhile, in parallel with the fabrication of the first electric wiring board 104, the second electric wiring board 105 is fabricated (FIG. 5C). In the present embodiment, a thick package substrate having a core layer as an inner layer is illustrated as an example of the second electric wiring board 105 in FIG. 5C. However, a coreless substrate may be used, as in the first electric wiring board 104.

Next, the connection terminal 106 and the GRIN lens 208 are formed on a surface of the second electric wiring board 105 (FIG. 5D). The connection terminal 106 may be, for example, a copper pillar, a solder ball, a copper-core solder ball, or a copper pin.

The GRIN lens 208 is directly adhesively fixed at a predetermined position of the second electric wiring board 105. Alternatively, a metal pattern may be formed on a bottom surface of the GRIN lens 208 or a bottom surface of a holder component of the GRIN lens 208 and then be metal-bonded to the second electric wiring board 105.

Next, the first electric wiring board 104 and the second electric wiring board 105 are bonded at panel level while surfaces of both the electric wiring boards are facing each other (FIG. 5E). As a result, a back surface of the first electric wiring board 104 serves as an upper surface of the package structure 21, and a front surface of the first electric wiring board 104 serves as the lower surface of the first electric wiring board 104 in the package structure 21.

A back surface of the second electric wiring board 105 serves as a bottom surface (lower surface) of the package structure 21, and a front surface of the second electric wiring board 105 serves as the upper surface of the second electric wiring board 105 in the package structure 21.

Therefore, the silicon photonics chip 101, the IC 102_1, and the passive component 103_1 are mounted on the lower surface of the first electric wiring board 104. In other words, the silicon photonics chip 101 is arranged between the first electric wiring board 104 and the second electric wiring board 105 facing each other.

The GRIN lens 208 is mounted on the upper surface of the second electric wiring board 105 by passing through the opening provided in the first electric wiring board 104.

The first electric wiring board 104 and the second electric wiring board 105 are electrically connected by the connection terminal 106.

Next, in order to increase mechanical strength of the package, a gap between both the boards is filled with the molding resin 107, and the molding resin is cured (FIG. 5F). The molding resin 107 is generally a colored opaque material, and thus it is desirable to fill a gap between the silicon photonics chip 101 and the GRIN lens 208 through which an optical signal propagates with a transparent resin material in advance.

Next, the prism 110 is arranged on the upper surface of the first electric wiring board 104 such that an inclined surface (reflective surface) of the prism is close to (faces) the emission end surface of the GRIN lens 208. Then, the adapter 111 is arranged on the prism 110 (FIG. 5G).

Hereinafter, adjustment of positions of the prism 110 and the adapter 111 will be described.

First, the ferrule 112 to which the multicore optical fiber 113 including the optical fibers 1133 and 113_4 is fixed is coupled to the adapter 111 and is fixed thereto by using the clip 114. The other end of the optical fiber 113_3 is connected to a light source for optical alignment, and the other end of the optical fiber 113_4 is connected to a photodetection device such as a photodetector (not illustrated).

Next, light for alignment is input from the light source to the optical fiber 113_3 and propagates to the silicon photonics chip 101 sequentially through the ferrule 112, the adapter 111, the prism 110, and the GRIN lens 208.

As illustrated in FIG. 4, the silicon photonics chip 101 includes a loopback optical circuit (second waveguide) 1013 for alignment.

In this configuration, as described above, the light for alignment input from the optical fiber 113_3 is reflected by the prism 110, is incident on the one end surface (left side in FIG. 4) of the GRIN lens 208, propagates through the paths 216_2_1 and 216_2_2, is input (coupled) to the second waveguide 1013 of the silicon photonics chip 101, is propagated through the second waveguide 1013, and is output from the silicon photonics chip 101.

The light output from the silicon photonics chip 101 is incident on the one end surface (left side in FIG. 4) of the GRIN lens 208, propagates through the paths 216_2_3 and 216_2_4, forms an image on the prism 110, is reflected, and is input to the optical fiber 113_4 via the adapter 111 and the ferrule 112.

The light for alignment is output from the other end of the optical fiber 113_4. An intensity (amount of light) of the output light is measured by the photodetector or the like connected to the other end of the optical fiber 113_4.

Next, the positions of the prism 110 and the adapter 111 are moved while the amount of light is being measured.

The prism 110 can move in a direction parallel to an optical axis of the GRIN lens 208 (an arrow 31 in FIG. 5G) on the horizontal plane and in a direction perpendicular to the direction (a direction perpendicular to the paper surface). By moving the prism 110 in the direction parallel to the optical axis of the GRIN lens 208 (the arrow 31 in FIG. 5G), it is possible to adjust a propagation length of light and adjust a focal point (focus).

The adapter 111 can move in the direction parallel to the optical axis of the GRIN lens 208 (an arrow 32 in FIG. 5G) and in the direction perpendicular to the direction (a direction perpendicular to the paper surface).

Positions obtained by moving the positions of the prism 110 and the adapter 111 to maximize the amount of light to be measured are optimal positions of the prism 110 and the adapter 111.

Finally, in the optimal positions, the prism 110 is adhesively fixed to the first electric wiring board 104, and the adapter 111 is adhesively fixed to the prism 110. The fixing method herein is not limited to adhesion and may be metal bonding. Further, a holder member or housing having an appropriate adhesion area may be designed and used.

The prism 110 may be fixed to the GRIN lens 208, instead of being fixed to the first electric wiring board 104.

The positions of the prism 110 and the adapter 111 are adjusted as described above.

Next, the clip 114 is removed, and the ferrule 112 and the optical fiber 113 are removed from the package structure 21 (FIG. 5H).

Next, the IC 102_2 is mounted on the upper surface of the first electric wiring board 104 (FIG. 5I). Here, not only the IC 102_2 but also the passive component 103_2 can be mounted.

The optical fiber 113 has already been removed in this state, and thus it is possible to easily perform surface planarization (reflow) by high-temperature heat treatment at panel level, as in normal mounting of electronic components.

Finally, BGA balls serving as the electric connection portions 109 for secondary mounting are formed on the bottom surface of the second electric wiring board 105 (FIG. 5J). Here, the process in FIG. 5J is unnecessary in a case where the electric connection portions are an LGA pad interface used in a socket method.

Finally, packages are divided by dicing (not illustrated).

The method of manufacturing a package structure according to the embodiments of the present invention has been described by using the package structure according to the second embodiment as an example. However, the method can also be applied to the package structure according to the first embodiment.

In the embodiments of the present invention, rigidity and mass productivity of the package can be improved by using a molding resin.

Components made from a molding resin have been conventionally used as electric and electronic components whose positional accuracy is about 10 μm.

Meanwhile, optical components are required to be positioned with high accuracy of about 0.1 μm and to have high reliability. Therefore, it is difficult to use components made from a molding resin. In a case where the silicon photonics and the optical fiber are adhesively fixed, durability and stability of adhesive fixation are insufficient in a process of fixing each component by molding, and the optical axis cannot be adjusted after the process of fixing each component by molding. Therefore, it is difficult to adjust the positions of the components and the optical axis with high accuracy.

In the embodiments of the present invention, the optical axis can be adjusted after each component is fixed by molding. Therefore, a molding resin can be used for mounting an optical component.

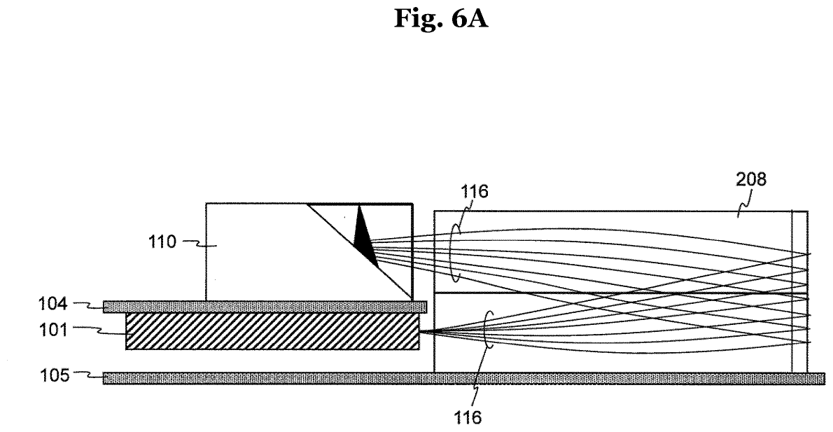

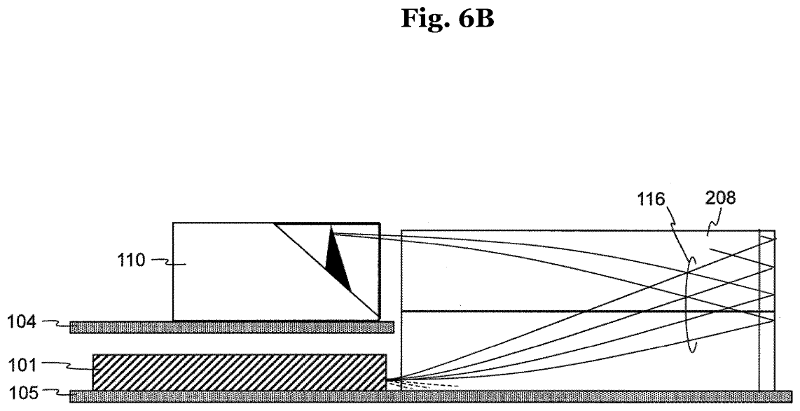

As illustrated in FIG. 6A, the embodiments of the present invention have the following effects by arranging the silicon photonics chip 101 on the lower surface of the first electric wiring board 104.

As illustrated in FIG. 6B, in a case where the silicon photonics chip 101 is arranged on the upper surface of the second electric wiring board 105, light propagating through the GRIN lens 208 is partially blocked, that is, so-called vignetting occurs, and not all light forms an image on the output side, for example, on the prism 110. As a result, optical loss in the GRIN lens 208 increases.

Meanwhile, as illustrated in FIG. 6A, in the embodiments of the present invention, the light propagating through the GRIN lens 208 is not blocked, that is, so-called vignetting does not occur, and all light forms an image on the output side, for example, on the prism 110. As a result, it is possible to suppress the optical loss in the GRIN lens 208 and efficiently propagate light.

The above effect is exerted not only in the second embodiment but also in the first embodiment.

According to the embodiments of the present invention, it is unnecessary to directly adhesively fix the optical fiber to the silicon photonics chip. This makes it possible to easily package the silicon photonics chip.

Further, the package structure and the optical module can be collectively manufactured at panel level, including an optical fiber interface.

Because the optical fiber interface is a detachable connector, the IC mounting, the PCB mounting, and other processes can be performed while the optical fiber is not being connected. This makes it possible to improve mass productivity and economic efficiency of optical mounting.

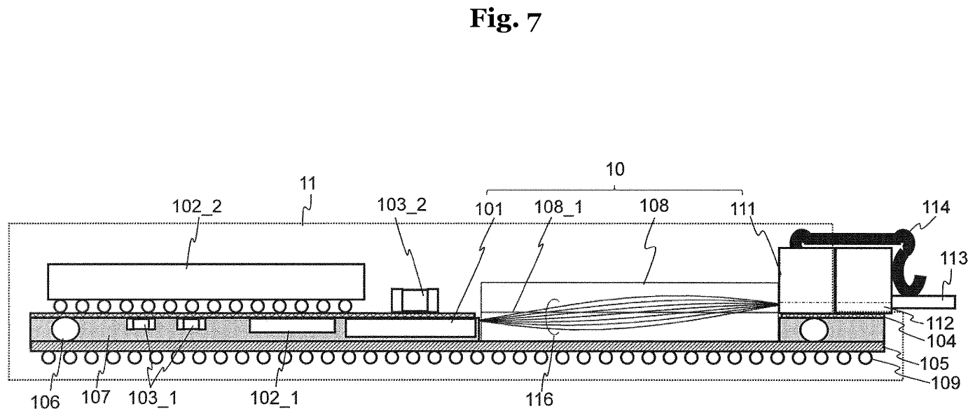

The reflection structure (prism) is used in the embodiments of the present invention. However, the GRIN lens may be directly connected to the adapter, without using the reflection structure (prism). For example, in a configuration of FIG. 7, the ferrule 112 to which the optical fiber 113 is fixed is connected to a surface of the adapter 111 opposite to a surface facing the GRIN lens 108. Input/output light propagates in the horizontal direction (direction parallel to the GRIN lens 108). The other configurations are substantially similar to those of the first embodiment.

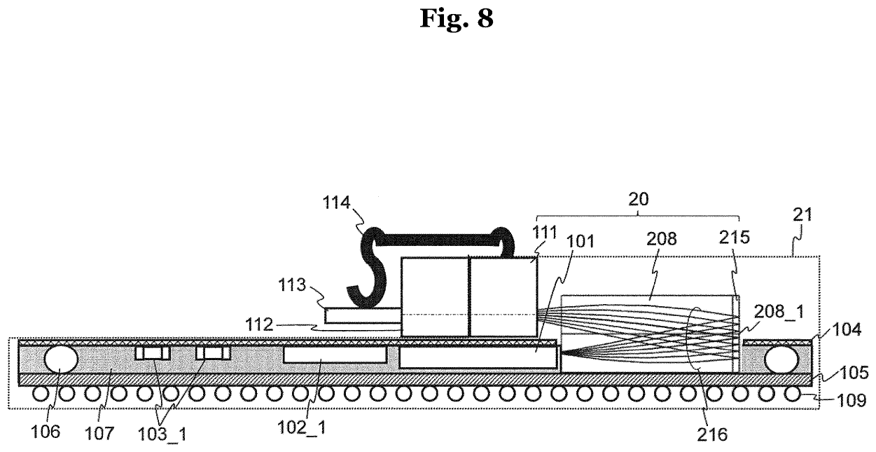

As illustrated in FIG. 8, the GRIN lens 208 may be directly connected to the adapter 111, without using the reflection structure (prism) 110. In this configuration, the ferrule 112 to which the optical fiber 113 is fixed is connected to a surface of the adapter 11 opposite to a surface facing the GRIN lens 208. Input/output light propagates in the horizontal direction (direction parallel to the GRIN lens 208). The other configurations are substantially similar to those of the second embodiment.

In the configuration in which the GRIN lens is directly connected to the adapter as described above, light is input and output between the GRIN lens and the adapter.

In the method of manufacturing the package structure, in a case where the GRIN lenses 108 and 208 are directly connected to the adapter 11 without using the prism 110, the adapter 111 may be adhesively fixed to the first electric wiring board 104 or may be adhesively fixed to the GRIN lenses 108 and 208.

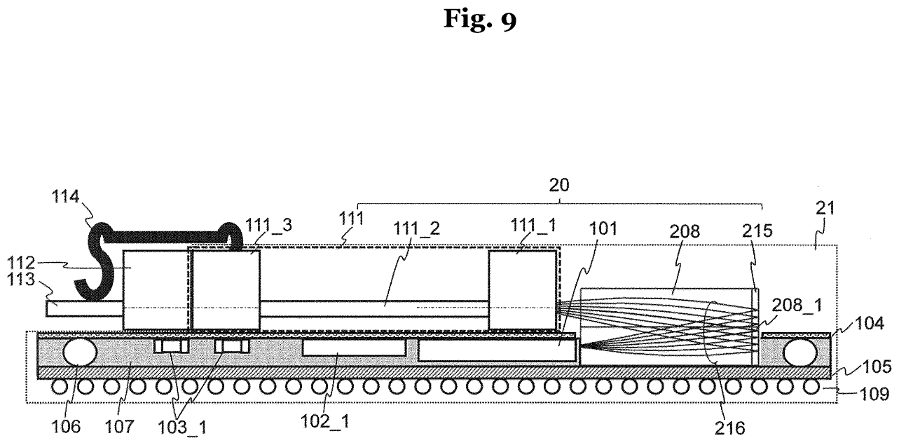

In the embodiments of the present invention, an example where the adapter includes one component has been described. However, the adapter may include a plurality of components and only needs to be detachably connected to the ferrule. For example, as illustrated in FIG. 9, the adapter 111 includes a fiber array structure 111_1 optically connected to the GRIN lens, a detachable portion 111_3 connected to the ferrule, and a light guide portion (optical fiber) 111_2 connecting the fiber array structure and the ferrule.

The optical connecting structure according to the embodiments of the present invention includes the adapter as an example, but may not include the adapter. In this case, the optical fiber or the ferrule to which the optical fiber is fixed may be directly connected to the GRIN lens.

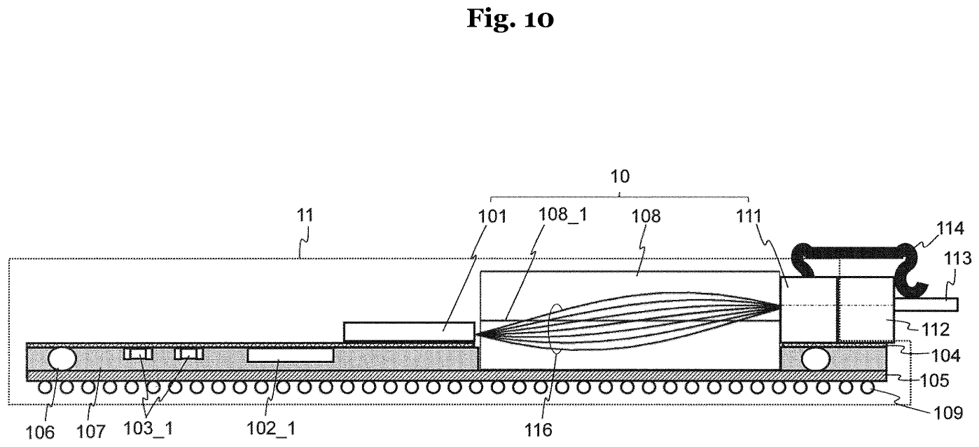

In the embodiments of the present invention, the silicon photonics chip is arranged between the first electric wiring board and the second electric wiring board as an example. However, the silicon photonics chip may be arranged on the upper surface of the first electric wiring board, in other words, on the surface opposite to the surface facing the second electric wiring board. In a configuration of FIG. 10, an end surface of the silicon photonics chip 101 faces one end surface of the GRIN lens 108, and light output from the silicon photonics chip 101 is incident on a lower side of the GRIN lens 108, is emitted from an upper side of the other end surface of the GRIN lens 108, and is input to the adapter 111. Light input to the silicon photonics chip 101 propagates through a path opposite to the above. In other words, the input/output light in the silicon photonics chip 101 propagates from one region to the other region of the GRIN lens 108 by using a horizontal plane including the center axis of the GRIN lens 108 as a boundary.

As described above, in the embodiments of the present invention, light input from one end surface of the GRIN lens propagates from one region to the other region of the GRIN lens 108 by using the horizontal plane including the center axis of the GRIN lens as a boundary and is output from the other end surface.

In the embodiments of the present invention, the silicon photonics chip separately includes a waveguide for optical signals and a waveguide for alignment as an example. However, the present invention is not limited thereto. As long as an optical element connected to the waveguide for optical signals can transmit light for alignment, the waveguide for optical signals may be used for alignment. Therefore, the waveguide for optical signals and the waveguide for alignment may not be separately provided. In a case where the optical element is a photodiode, the waveguide for optical signals only needs to have an input port.

In the embodiments of the present invention, the silicon photonics chip is mounted on the lower surface of the first electric wiring board in the face-down manner as an example. However, the silicon photonics chip may be mounted in a face-up manner. In that case, electrical connection to the first electric wiring board 104 is achieved by wire bonding or a through-silicon via (TSV).

The silicon photonics chip may be mounted on the upper surface of the second electric wiring board in either the face-up manner or the face-down manner. Even if any mounting method is used, light from the silicon photonics chip provided in the gap between the first electric wiring board and the second electric wiring board is guided to the upper surface side of the first electric wiring board by using a meandering propagation characteristic of the GRIN lens.

In the embodiments of the present invention, the silicon photonics chip is used as an example. However, the present invention is not limited thereto, and an optical waveguide device made from another material may be used. For example, a planar lightwave circuit made from quartz glass or the like or an optical waveguide device made from indium phosphide (InP) may be used. The optical waveguide device may not be made from a single material such as silicon. For example, the optical waveguide device may be a device in which an InP-based optical semiconductor light emitting element or a lithium niobate-based optical modulator is integrated on a chip.

Instead of the optical waveguide device, an optical element having no waveguide, such as a semiconductor laser or a photodiode, may be used. In this case, in the manufacturing process of the package structure, for example, the amount of light can be adjusted by measuring output light from the semiconductor laser by using the photodetection device at the other end of the optical fiber. Alternatively, the amount of light can be measured and adjusted by receiving input light from the light source at the other end of the optical fiber by the photodiode.

In the embodiments of the present invention, a multicore optical fiber including a plurality of optical fibers is used as an example, but a single core optical fiber may be used. The single core optical fiber can be used in a case where, for example, a semiconductor laser or a photodiode is used as the optical element as described above.

In the embodiments of the present invention, one GRIN lens is used as an example. However, a plurality of GRIN lenses may be used. For example, two GRIN lenses each may be used to propagate input light and output light. Alternatively, in a case where a plurality of adapters is arranged, light may be input and output between the plurality of GRIN lenses and the plurality of adapters.

In the embodiments of the present invention, a molding resin is used as an example, but the present invention is not limited thereto. The molding resin may not be used in a case where the components can be firmly mounted in the package structure.

The embodiments of the present invention show examples of the structures, dimensions, materials, and the like of the components in the configuration, manufacturing method, and the like of the package structure of the optical components. However, the present invention is not limited thereto. The embodiments of the present invention only need to have the function and effect of the package structure of the optical components.

### INDUSTRIAL APPLICABILITY

The embodiments of the present invention relate to an optical module of an optical component and can be applied to devices and systems for optical communication or the like.

### REFERENCE SIGNS LIST

1 Optical module
10 Optical connecting structure
11 Package structure
101 Silicon photonics chip
102_1, 102_2 IC
103_1, 103_2 Passive component
104 First electric wiring board
105 Second electric wiring board
106 Connection terminal
107 Molding resin
108 GRIN lens
109 Electric connection portion
110 Reflection structure (prism)
111 Adapter
112 Ferrule
113 Optical fiber

1.-13. (canceled)

14. An optical connecting structure in a package structure connected to an optical fiber and comprising a first electric wiring board and a second electric wiring board facing the first electric wiring board, the optical connecting structure comprising:
an optical element arranged on the first electric wiring board or the second electric wiring board; and
a gradient index (GRIN) lens arranged on a surface of the second electric wiring board facing the first electric wiring board, wherein a first end surface of the GRIN lens faces an end surface of the optical element.

15. The optical connecting structure according to claim 14, further comprising a reflective film on a second end surface of the GRIN lens.

16. The optical connecting structure according to claim 14, further comprising an adapter detachably connected to the optical fiber, wherein light is input and output between the GRIN lens and the adapter.

17. The optical connecting structure according to claim 16, wherein:
the optical fiber comprises a plurality of fibers;
the light input from a first fiber of the plurality of fibers sequentially propagates through the adapter and the GRIN lens and is input to the optical element; and
the light is output from the optical element, sequentially propagates through the GRIN lens and the adapter, and is input to a second fiber of the plurality of fibers.

18. The optical connecting structure according to claim 16, further comprising a reflection structure arranged on a surface of the first electric wiring board opposite to the second electric wiring board and between the GRIN lens and the adapter.

19. The optical connecting structure according to claim 14, wherein a center axis of the GRIN lens is in substantially the same plane as the first electric wiring board.

20. The optical connecting structure according to claim 14, wherein the optical element is arranged between the first electric wiring board and the second electric wiring board.

21. The optical connecting structure according to claim 14, wherein the optical element is arranged on a surface of the first electric wiring board facing the second electric wiring board.

22. The optical connecting structure according to claim 14, wherein the optical element comprises a waveguide through which light for alignment propagates.

23. A package structure comprising:
a first electric wiring board;
a second electric wiring board; and
an optical connecting structure comprising:
an optical element arranged on the first electric wiring board or the second electric wiring board; and
a gradient index (GRIN) lens arranged on a surface of the second electric wiring board facing the first electric wiring board, wherein a first end surface of the GRIN lens faces an end surface of the optical element.

24. The package structure according to claim 23, further comprising a molding resin between the first electric wiring board and the second electric wiring board.

25. The package structure according to claim 23, further comprising a reflective film on a second end surface of the GRIN lens.

26. The package structure according to claim 23, wherein the optical connecting structure is connected to an optical fiber, and wherein the package structure further comprises an adapter detachably connected to the optical fiber, wherein light is input and output between the GRIN lens and the adapter.

27. The package structure according to claim 26, wherein:
the optical fiber comprises a plurality of fibers;
the light input from a first fiber of the plurality of fibers sequentially propagates through the adapter and the GRIN lens and is input to the optical element; and
the light is output from the optical element, sequentially propagates through the GRIN lens and the adapter, and is input to a second fiber of the plurality of fibers.

28. The package structure according to claim 26, further comprising a reflection structure arranged on a surface of the first electric wiring board opposite to the second electric wiring board and between the GRIN lens and the adapter.

29. The package structure according to claim 24, wherein the optical element is arranged between the first electric wiring board and the second electric wiring board.

30. The package structure according to claim 24, wherein the optical element is arranged on a surface of the first electric wiring board facing the second electric wiring board.

31. The package structure according to claim 24, wherein the optical element comprises a waveguide through which light for alignment propagates.

32. An optical module comprising:
the package structure according to claim 23;
an optical fiber connected to the optical connecting structure; and
a ferrule.

33. A method of manufacturing a package structure, the method comprising:
mounting an optical element comprising a waveguide for alignment on a surface near an opening of a first electric wiring board;
mounting a gradient index (GRIN) lens on a surface of a second electric wiring board;
causing the GRIN lens to pass through the opening of the first electric wiring board, causing the surface of the first electric wiring board and the surface of the second electric wiring board to face each other, and bonding the first electric wiring board and the second electric wiring board;
forming a molding resin between the first electric wiring board and the second electric wiring board;
arranging an adapter so as to input and output light between the adapter and the GRIN lens;
detachably connecting a ferrule to which a multicore optical fiber is fixed to the adapter;
inputting light to a first optical fiber of the multicore optical fiber;
measuring an intensity of the light propagated through the waveguide and output from a second optical fiber of the multicore optical fiber; and
moving a position of the adapter to fix the adapter at a position where the intensity of the light is maximum.
